(19) United States
(12) Patent Application Publication
(10) Pub. No.: US 2026/0228536 A1
(43) Pub. Date: Aug. 6, 2026

(54) PATCH-BASED SELF-SUPERVISED LEARNING DEVICE AND METHOD FOR ANOMALY DETECTION IN MULTIVARIATE TIME SERIES DATA

(71) Applicant: INDUSTRY FOUNDATION OF CHONNAM NATIONAL UNIVERSITY, Gwangju (KR)

(72) Inventors: Jinsul KIM, Gwangju (KR); Seungmin OH, Gwangju (KR)

(73) Assignee: INDUSTRY FOUNDATION OF CHONNAM NATIONAL UNIVERSITY, Gwangju (KR)

(21) Appl. No.: 19/419,504

(22) Filed: Dec. 15, 2025

(30) Foreign Application Priority Data
Feb. 4, 2025 (KR) 10-2025-0014129

(51) Int. Cl. G06N 3/0895; G06N 3/045

(52) U.S. Cl. CPC G06N 3/0895; G06N 3/045

(57) ABSTRACT

Provided are a patch-based self-supervised learning device for anomaly detection of multivariate time series data, and a method thereof. The present device includes a pre-training unit that pre-trains a model so as to restore the multivariate time series data by dividing the multivariate time series data into a plurality of patches, generating a patch, which is randomly masked, from among the plurality of patches, and reconstructing the masked patch, and a downstream unit that performs self-learning so as to divide the multivariate time series data into the plurality of patches, randomly apply anomaly enhancement to the plurality of patches, and detect a patch, to which the anomaly enhancement is applied, by using the pre-trained model.

### CROSS-REFERENCE TO RELATED APPLICATIONS

A claim for priority under 35 U.S.C. 517 119 is made to Korean Patent Application No. 10-2025-0014129 filed on Feb. 4, 2025 in the Korean Intellectual Property Office, the entire contents of which are hereby incorporated by reference.

### BACKGROUND

Embodiments of the present disclosure described herein relate to a learning device for data anomaly detection and a method thereof, and more particularly, relate to a patch-based self-supervised learning device for anomaly detection in multivariate time series data and a method thereof.

The importance of multivariate time series data is highlighted due to the massive data management and optimization demands occurring across diverse industries such as manufacturing, finance, biotechnology, and energy.

The multivariate time series data may refer to data having a plurality of values at each time unit and may be data recorded sequentially over time. The multivariate time series data may include a plurality of variables.

This data includes interactions between multiple variables, and effectively processing and analyzing them is a key challenge.

Anomaly detection is a critical technology for preventing problems by early detection of abnormal states or events deviating from normal system operation.

In manufacturing, early detection of small defects may prevent large-scale failures; in finance, detection of abnormal transaction patterns may prevent financial fraud; and, energy may be efficiently managed by adjusting a power generation amount through power demand forecasting.

Conventional statistical techniques like ARIMA and ARMA have been used as an early anomaly detection method, but they struggle to effectively handle the complex relationships inherent in multivariate data.

Deep learning has a strong point at learning complex relationships and features, but the multivariate time series data typically has limited quantities, thereby making it difficult to train a deep learning model requiring large datasets.

Moreover, a process of labeling anomaly data is time-consuming and costly.

To solve the issues, unsupervised learning-based anomaly detection methods have emerged. However, conventional unsupervised learning methods are sensitive to noise and struggle to learn or predict new anomaly patterns.

Deep learning-based models like Transformers, TCNs, and SCINet have been researched for time series prediction and anomaly detection. However, conventional time series anomaly detection models are limited to learning either a local pattern (a feature of an individual time interval) or a global pattern (a trend in the entire time series), thereby making it difficult to effectively handle both simultaneously.

Furthermore, channel-independent approaches have recently proven effective in time series forecasting, but they risk overlooking important patterns by ignoring interactions between variables in anomaly detection fields.

### SUMMARY

Embodiments of the present disclosure provide a device and a method for performing learning such that anomalies in multivariate time series data are detected in an optimized manner.

Problems to be solved by the present disclosure are not limited to the problems mentioned above, and other problems not mentioned will be apparent by those skilled in the art from the following description.

According to an embodiment, a patch-based self-supervised learning device for anomaly detection in multivariate time series data includes a memory that stores at least one process for performing an anomaly detection operation on the multivariate time series data, and a processor that performs the anomaly detection operation on the multivariate time series data based on the at least one process. The processor includes a pre-training unit that pre-trains a model so as to restore the multivariate time series data by dividing the multivariate time series data into a plurality of patches, generating a patch, which is randomly masked, from among the plurality of patches, and reconstructing the masked patch, and a downstream unit that performs self-learning so as to divide the multivariate time series data into the plurality of patches, randomly apply anomaly enhancement to the plurality of patches, and detect a patch, to which the anomaly enhancement is applied, by using the pre-trained model.

In this case, the pre-training unit may include a data input unit that inputs the multivariate time series data, a first patching unit that divides data input from the data input unit into the plurality of patches, a masking unit that randomly selects the plurality of patches and masks a data value, a first embedding unit that performs high-dimensional feature transformation by applying a predetermined algorithm on the masked patch, a first transformer encoder unit that trains the model so as to receive data, which is obtained by performing the high-dimensional feature transformation, and outputs an output value used for data restoration, a first linear layer unit that performs a restoration task on the masked patch by using the output value output from the first transformer encoder unit, a reconstruction unit that estimates original data before masking and reconstructs data restored by the first linear layer unit based on the estimated original data, and a first loss unit that calculates a difference between the original data and the data restored through the reconstruction unit in terms of a time and a frequency and to use the difference for training.

Moreover, the first patching unit may divide the input data into a patch unit having a specific patch size and divide the data into the plurality of patches by selectively applying either an overlapping method or a non-overlapping method, and may determine the patch unit based on an input data length, a patch size, and a stride when applying the overlapping method.

Furthermore, the masking unit may randomly select and mask a patch at a specific ratio from among the plurality of patches, may perform masking by setting a data value included in the selected patch to 0 or replacing the data value with a specific embedding vector, and may vary a ratio of the masked patch, and may gradually increase a masking ratio as the number of training iterations increases.

Also, the masking unit may select a patch to be masked based on a temporal position or a specific pattern of data included in the plurality of patches.

Besides, the first embedding unit may encode a temporal position of input data patched into the plurality of patches, may expand the encoded result to a fixed embedding size, and may perform the high-dimensional feature transformation through value embedding.

In addition, the first transformer encoder unit may train the model by receiving input data transformed by the first embedding unit in a patch unit, and may perform a high-dimensional processing mechanism on the data input in the patch unit. A vector value used in the high-dimensional processing mechanism may use data output from the first embedding unit.

Moreover, the first linear layer unit may perform a restoration task on the masked patch by deriving a prediction result or refining a final representation of data by using the output value from the first transformer encoder unit. The output value output from the first transformer encoder unit may include a feature vector. The first linear layer unit may receive the feature vector and restore data for the masked patch.

Furthermore, the reconstruction unit may reconstruct the restored data such that a difference between the original data and the restored data is minimized, by predicting or estimating the original data before masking.

Also, the first loss unit may include a time loss function that calculates a difference between the restored data and the original data from a temporal perspective, and a frequency loss function that calculates a difference in a frequency spectrum by transforming the restored data and the original data into a frequency domain, and may train the model by reflecting both a time loss and a frequency loss.

Besides, the downstream unit may include a second patching unit that receives the multivariate time series data and divides the multivariate time series data into the plurality of patches, a random selection unit that randomly selects the plurality of patches, an anomaly augmentation unit that synthesizes anomaly data such that the anomaly enhancement is applied to data of the randomly selected patch, a second embedding unit that performs high-dimensional feature transformation by applying a predetermined algorithm to a patch, to which the anomaly enhancement is applied, a second transformer encoder unit that trains the model so as to receive data, which is obtained by performing the high-dimensional feature transformation, and outputs an output value used for the anomaly detection, a second linear layer unit that performs binary classification used to calculate an anomaly score by using the output value from the second transformer encoder unit, an anomaly score prediction unit that predicts the anomaly score for each of the plurality of patches by using a value output from the second linear layer unit, and a second loss unit that calculates a difference between a prediction result of the anomaly score and a result of an actual anomaly score and uses the difference for training.

In addition, the second patching unit may divide input data into a patch unit having a specific patch size and divide the data into the plurality of patches by selectively applying either an overlapping method or a non-overlapping method, and may determine the patch unit based on an input data length, a patch size, and a stride when applying the overlapping method.

Moreover, the random selection unit may randomly select patches at a specific ratio from among the plurality of patches, and variably set the ratio depending on a fixed ratio or a training stage, and may vary the ratio of the randomly selected patches, and gradually decrease a selection ratio as the number of training iterations increases.

Furthermore, the anomaly augmentation unit may generate anomaly data by applying a predetermined technique to a patch selected by the random selection unit.

Also, the second embedding unit may encode a temporal position of input data patched into the plurality of patches, may expand the encoded result to a fixed embedding size, and may perform high-dimensional feature transformation through value embedding.

Besides, the second transformer encoder unit may train the model by receiving input data transformed by the second embedding unit in a patch unit, and may perform a high-dimensional processing mechanism on the data input in the patch unit. A vector value used in the high-dimensional processing mechanism may use data output from the second embedding unit.

In addition, the second linear layer unit may perform binary classification that calculates an anomaly score for a selected patch by using the output value from the second transformer encoder unit, and may perform training to convert the output value into a probability value between 0 and 1.

Moreover, the output value output from the second transformer encoder unit may include a feature vector. The second linear layer unit may receive the feature vector and then perform binary classification that calculates an anomaly score for the selected patch.

Furthermore, the second loss unit may perform training by calculating a binary cross-entropy loss value such that the model trains a binary classification problem of normal and abnormal, and a difference between the calculated anomaly score and actual data is minimized.

According to an embodiment, a patch-based self-supervised learning method for anomaly detection of multivariate time series data, which is performed by a device, includes dividing the multivariate time series data into a plurality of patches, generating a patch, which is randomly masked, from among the plurality of patches, and pre-training a model so as to restore the multivariate time series data by reconstructing the masked patch, and dividing the multivariate time series data into the plurality of patches, randomly applying anomaly enhancement to the plurality of patches, and performing self-learning so as to detect a patch, to which the anomaly enhancement is applied, by using the pre-trained model.

Besides, a computer program stored in a computer-readable recording medium for implementing the present disclosure may be further provided.

In addition, a computer-readable recording medium for recording a computer program for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram illustrating a patch-based self-supervised learning device for anomaly detection of multivariate time series data, according to an embodiment of the present disclosure;

FIG. 2 is a flowchart illustrating a patch-based self-supervised learning method for anomaly detection of multivariate time series data, according to an embodiment of the present disclosure;

FIG. 3 is a diagram for describing a pre-training unit, according to an embodiment of the present disclosure;

FIG. 4 is a diagram for describing a downstream unit, according to an embodiment of the present disclosure;

FIG. 5 is a diagram for describing anomaly data to which anomaly enhancement according to an embodiment of the present disclosure is applied; and

FIG. 6 is a graph illustrating the improvement in anomaly detection rate when the learning method according to an embodiment of the present disclosure is used.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, ‘the present device’, ‘a device according to an embodiment of the present disclosure’ or ‘a patch-based self-supervised learning device for anomaly detection of multivariate time series data according to an embodiment of the present disclosure’ includes all various devices capable of providing results to a user by performing arithmetic processing. For example, the device according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Functions related to artificial intelligence according to an embodiment of the present disclosure are operated through a processor and a memory. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

The predefined operating rule or the artificial intelligence model is created through learning. Here, being created through learning means creating the predefined operating rule or the artificial intelligence model configured to perform desired features (or purposes) as a basic artificial intelligence model is learned by using pieces of learning data by a learning algorithm. This learning may be performed by a device itself, on which the artificial intelligence according to an embodiment of the present disclosure is performed, or may be performed through a separate server and/or system. For example, the learning algorithm may include supervised learning, unsupervised learning, semi-supervised learning, or reinforcement learning, but may not be limited to the above example.

An artificial intelligence model may be composed of a plurality of neural network layers. The plurality of neural network layers respectively have a plurality of weight values, and each of the plurality of neural network layers performs neural network calculation through calculations between the calculation result of the previous layer and the plurality of weight values. The plurality of weight values of the plurality of neural network layers may be optimized by the learning result of the artificial intelligence model. For example, during a learning process, the plurality of weight values may be updated such that a loss value or a cost value obtained from the artificial intelligence model is reduced or minimized. The artificial neural network may include a deep neural network (DNN). The artificial neural network may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the above-described example.

According to an embodiment of the present disclosure, a processor may implement artificial intelligence. The artificial intelligence may refer to an artificial neural network-based machine learning method that allows a machine to perform training by simulating human biological neurons. The methodology of artificial intelligence may be classified as supervised learning, in which a solution (output data) to a problem (input data) is determined by providing input data and output data together as training data depending on a learning method, unsupervised learning, in which only input data is provided without output data, and thus the solution (output data) to the problem (input data) is not determined, and reinforcement learning, in which a reward is given from an external environment whenever an action is taken in a current state, and thus learning progresses to maximize this reward. Moreover, the methodology of artificial intelligence may also be categorized depending on architecture, which is the structure of the learning model. The architecture of deep learning technology widely used may be categorized into convolutional neural networks (CNN), recurrent neural networks (RNN), transformers, and generative adversarial networks (GAN).

Each of a device and a system according to an embodiment of the present disclosure may include an artificial intelligence model. The artificial intelligence model may be a single artificial intelligence model or may be implemented as a plurality of artificial intelligence models. The artificial intelligence model may be composed of neural networks (or artificial neural networks) and may include a statistical learning algorithm that mimics biological neurons in machine learning and cognitive science. The neural network may refer to a model as a whole having the ability to solve problems as artificial neurons (nodes), which form a network by connecting synapses, changes the strength of their synaptic connections through learning. Neurons in the neural network may include the combination of weight values or biases. The neural network may include one or more layers consisting of one or more neurons or nodes. For example, the present device may include an input layer, a hidden layer, and an output layer. The neural network constituting the present device may infer the result (output) to be predicted from an arbitrary input by changing a weight value of a neuron through learning.

The processor may create a neural network, may train or learn a neural network, or may perform operations based on received input data, and then may generate an information signal or may retrain the neural network based on the performed results. Models of a neural network may include various types of models such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) Network, and a classification network, but is not limited thereto. The processor may include one or more processors for performing computations according to the models of the neural network. For example, the neural network may include a deep neural network.

It will be understood by those skilled in the art that a neural network may include any neural network, but is not limited to a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an embodiment of the present disclosure, the processor may use various artificial intelligence structures and algorithms such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) Network, a classification network, Generative Modeling, eXplainable AI, Continual AI, Representation Learning, AI for Material Design, algorithms for natural language processing (e.g., BERT, SP-BERT, MRC/QA, Text Analysis, Dialog System, GPT-3, and GPT-4), algorithms for vision processing (e.g., Visual Analytics, Visual Understanding, Video Synthesis, and ResNet), algorithms for data intelligence (e.g., Anomaly Detection, Prediction, Time-Series Forecasting, Optimization, Recommendation, and Data Creation), but is not limited thereto. Hereinafter, an embodiment of the present disclosure will be described in detail with reference to the accompanying drawings.

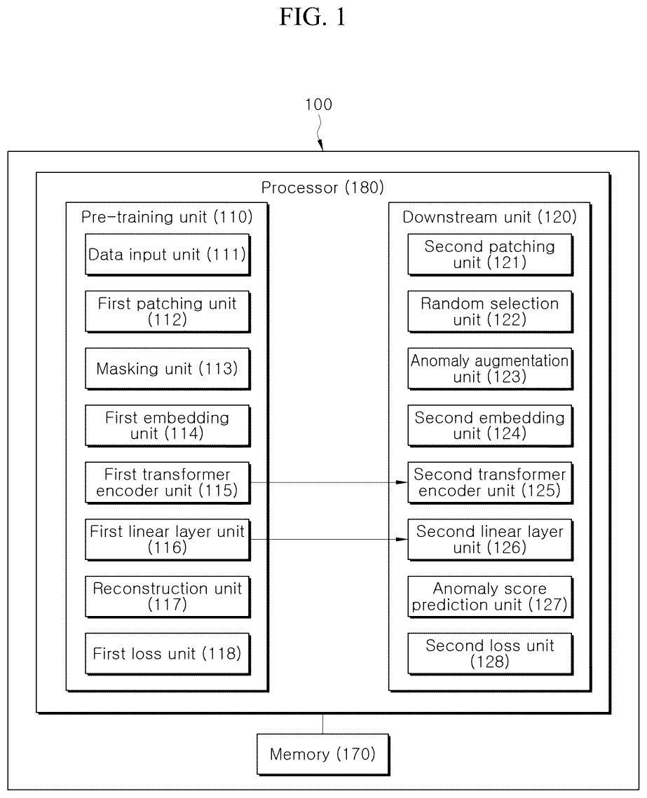

FIG. 1 is a diagram illustrating a patch-based self-supervised learning device for anomaly detection of multivariate time series data, according to an embodiment of the present disclosure.

Referring to FIG. 1, a patch-based self-supervised learning device 100 for anomaly detection in multivariate time series data according to an embodiment of the present disclosure may include a memory 170 storing at least one process for performing anomaly detection in multivariate time series data, and a processor 180 that performs the anomaly detection in the multivariate time series data based on the at least one process.

The device 100 according to an embodiment of the present disclosure may be configured to be operated or implemented independently, or may be implemented to be operated by being connected to an external device with or without wires.

When the device according to an embodiment of the present disclosure is configured to be connected with an external device via wired/wireless connection, a communication module (not shown) for performing wireless communication and an interface module (not shown) may be further included.

For example, the communication module may include one or more components capable of communicating with an external device, and may include, for example, at least one of a wireless communication module, a short-range communication module, and a location information module.

An interface module serves as a gateway for connecting various types of external devices to the device 100 according to an embodiment of the present disclosure. The interface unit module include at least one of a wired/wireless headset port, an external charger port, a wired/wireless data port, a memory card port, a port for connecting a device equipped with a subscriber identification module (SIM), an audio input/output (I/O) port, a video I/O port, and an earphone port. In the present device, appropriate control related to an external device connected to the interface unit may be performed.

The memory 170 may store data for supporting various functions of the present device, and a program for operations of the processor, may store pieces of input/output data (e.g., music files, still images, videos, and the like), and may store a plurality of application programs (or applications) running on the present device, pieces of data for operations of the present device, and instructions. At least part of the application programs may be downloaded from an external server through wireless communication.

Moreover, the memory 170 may store at least one process (or a task, an operation, a function, a control method, a procedure, data, an algorithm, a program, etc.) that performs the method according to an embodiment of the present disclosure. This at least one process may be executed under the control of the processor 180 and may refer to information used by the processor 180 to implement the method according to an embodiment of the present disclosure. For example, the memory may store at least one process for performing anomaly detection on multivariate time series data.

The memory 170 may include the type of a storage medium of at least one of a flash memory type, hard disk type, a solid state disk (SSD) type, a silicon disk drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the memory may be separate from the present device, but may be a database connected by wire or wirelessly.

The processor 180 may be implemented with the memory 170 that stores data regarding an algorithm for controlling operations of components within the present device, or a program for implementing the algorithm, and the at least one processor (not illustrated) that perform a process described in the present disclosure by using data stored in the memory. In this case, the memory 170 and the processor 180 may be implemented as separate chips (or modules), respectively. However, an embodiment is not limited thereto, and each of the memory 170 and the processor 180 may be implemented as a single chip (or a single module).

Referring to FIG. 1, the processor 180 may perform an anomaly detection operation on multivariate time series data based on at least one process stored in the memory 170 and may learn the performed result.

To this end, the processor 180 may include a pre-training unit 110 and a downstream unit 120.

The pre-training unit 110 may include a data input unit 111, a first patching unit 112, a masking unit 113, a first embedding unit 114, a first transformer encoder unit 115, a first linear layer unit 116, a reconstruction unit 117, and a first loss unit 118.

The downstream unit 120 may include a second patching unit 121, a random selection unit 122, an anomaly augmentation unit 123, a second embedding unit 124, a second transformer encoder unit 125, a second linear layer unit 126, an anomaly score prediction unit 127, a second loss unit 128.

Each component included in the processor 180 listed above may be implemented in hardware or in the form of a chip, IC, a hardware module, equipment, or a device. However, an embodiment is not limited thereto, and each component included in the processor 180 may be implemented as a component (block or piece) within the processor 180 in a software method such that each component performs its own function, operation, and control.

The functions, operations, and control methods respectively performed by the components included in the processor 180 may be understood as being performed by the processor 180 or the present device 100.

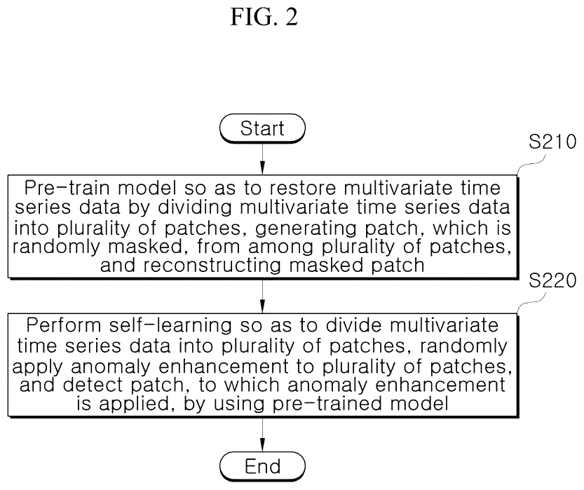

FIG. 2 is a flowchart illustrating a patch-based self-supervised learning method for anomaly detection of multivariate time series data, according to an embodiment of the present disclosure.

Referring to FIG. 2, a patch-based self-supervised learning method for anomaly detection in multivariate time series data according to the device 100 includes pre-training a model so as to restore the multivariate time series data by dividing, by the pre-training unit 110, the multivariate time series data into a plurality of patches, generating a patch, which is randomly (arbitrarily) masked, from among the plurality of patches, and reconstructing the masked patch (S210).

Afterwards, the patch-based self-supervised learning method for anomaly detection in multivariate time series data according to the device 100 include performing self-learning so as to divide, by the downstream unit 120, the multivariate time series data into the plurality of patches, randomly apply anomaly enhancement to the plurality of patches, and detect a patch, to which the anomaly enhancement is applied, by using the pre-trained model (S220).

The model may be an artificial intelligence model described above in this specification. The model may be a model learned to perform an anomaly detection operation on multivariate time series data.

Furthermore, the model may be the pre-training unit 110 or the downstream unit 120, or may be implemented as a combination of at least one component included therein. For example, the model may be implemented as at least one component included in the pre-training unit 110 (e.g., at least one of the first embedding unit 114, the first transformer encoder unit 115, the first linear layer unit 116, and the reconstruction unit 117).

Furthermore, the model may be the first transformer encoder unit 115 and the second transformer encoder unit 125 itself, may be the entire processor 180, or may be the device itself according to an embodiment of the present disclosure.

The patch-based self-supervised learning method (or technique) for anomaly detection in multivariate time series data according to an embodiment of the present disclosure consists of two main stages.

The first stage is a pre-training stage that performs self-supervised learning, and the second stage is a supervised learning stage for anomaly detection. The present disclosure may use and utilize the multivariate time series data.

The first stage includes patching the input multivariate time series data into patches, and randomly masking the patched data, expanding features of the input data such that the patches effectively process data by using a transformer encoder through positional encoding and projection, and performing learning to predict the masked patch through a linear layer by using the transformer encoder.

In the case, the processor 180 may use the values output from the embedding unit when the Transformer Encoder sets a query, a key, and a value. The Value Embedding method uses 1D convolution. Learning may be performed with weights initialized through pre-training. A loss function of learning may consider both temporal and frequency losses.

The second stage includes patching the input multivariate time series data into patches, and randomly selecting the patched data.

These randomly selected patches may apply soft replacement, uniform replacement, and peak noise through anomaly augmentation with a certain probability. In the case, data, to which anomaly augmentation is applied, is generated as a label of 1. Data, to which anomaly augmentation is not applied, is generated as a label of 0.

Here, the supervised learning may be performed by using the pre-trained transformer encoder in the first stage, and anomaly situations may be detected (or learning to detect) based on a binary cross-entropy loss function.

According to an embodiment of the present disclosure, a patch-based self-supervised learning and supervised learning framework may be provided for anomaly detection in multivariate time series data. The framework consists of two stages, and may provide a technology and a method to effectively perform anomaly detection through data patching processes, representation learning, channel dependency learning, and downstream approaches.

According to an embodiment of the present disclosure, to address challenges in anomaly detection of multivariate time series data such as insufficient data, labeling costs, ignoring interactions between variables, limitations in learning local and global dependencies, and difficulties in processing noise and novel anomaly patterns, a self-supervised learning framework utilizing patch-based learning and transformer models may be provided.

In this way, the diversity of anomaly data may be learned by using data augmentation techniques; both low-frequency and high-frequency elements may be reflected through frequency domain learning; and inter-channel dependencies may be comprehensively modeled, thereby implementing a more sophisticated and robust anomaly detection system.

Hereinafter, according to an embodiment of the present disclosure, the patch-based self-supervised learning device and method (or technology) will be described in more detail for detecting anomaly detection in multivariate time series data by using each component.

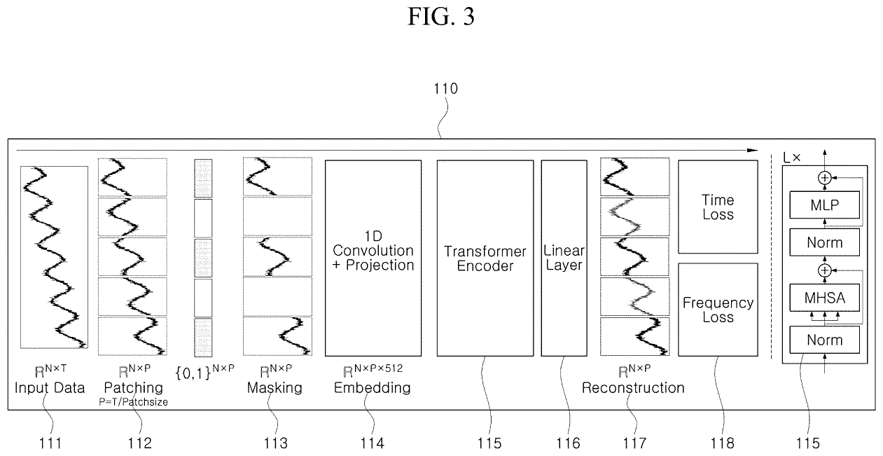

FIG. 3 is a diagram for describing a pre-training unit, according to an embodiment of the present disclosure.

The pre-training unit 110 includes the data input unit 111 that inputs the multivariate time series data, the first patching unit 112 that divides the input data into a plurality of patches, the masking unit 113 that randomly selects the plurality of patches and masks a data value, the first embedding unit (Embedding) 114 that performs high-dimensional feature transformation by applying a predetermined algorithm on the masked patch, the first transformer encoder unit (transformer encoder) 115 that trains the model to receive the high-dimensional feature-transformed data and to output an output value used for data restoration, the first linear layer unit (Linear Layer) 116 that performs a restoration task on the masked patch by using the output value output from the first transformer encoder unit, the reconstruction unit 117 that estimates original data before masking and reconstructs the data restored by the first linear layer unit based on the estimated original data, and the first loss unit 118 that calculates a difference between the original data and the data reconstructed through the reconstruction unit in terms of a time and a frequency and uses the difference for training.

The data input unit 111 may receive the multivariate time series data.

The multivariate time series data may refer to data recorded sequentially over time, may mean primarily used in various fields such as finance, meteorology, and sensor data, may be data for identifying trends, seasonality, and outliers by analyzing data change patterns over time, and may be multivariate data composed of multiple variables (features). Each observation value may include contain values for several variables.

For example, the multivariate time series data may include data that changes over time such as power consumption data, power generation data, and temperature data, as well as sensor data from factory equipment, stock market data, and patient monitoring data. In this specification, multivariate data may be primarily used, but it is not limited to, and univariate data may also be used.

The first patching unit 112 may divide the input data into patch units of a specific patch size and may divide the data into a plurality of patches by selectively applying either an overlapping method or a non-overlapping method.

Here, when applying the overlapping method, the first patching unit 112 may determine the patch units based on an input data length, a patch size, and a stride.

The first patching unit 112 performs a patching process by dividing the input data into patches of the patch size. In this case, the patching process may or may not use an overlapping method. For example, when input time series data has a size of 128, the patch size is set to 4, and non-overlapping is set, the number of patches may be 32. When the overlapping method is set, it is set to “{(L−P)/S}+1” (here, a (L−P)/S value may be a discard or drop value, and may be a floor function). Here, ‘L’ is set to the data length; ‘P’ is set to the patch size; and ‘S’ is set to the stride.

In other words, the first patching unit 112 may include a process of dividing the input data into patches of a specific patch size, and may include a function of generating a patch unit based on the input data length ‘L’, the patch size ‘P’, and the stride ‘S’, and selectively applying either the overlapping method or the non-overlapping method.

The masking unit 113 may randomly select patches at a specific ratio from among the plurality of patches and may mask the selected patches.

Here, the masking unit 113 may perform masking by setting a data value included in the selected patch to 0 or replacing it with a specific embedding vector.

Moreover, the masking unit 113 may vary the ratio of patches to be masked, and may gradually increase a masking ratio as the number of training iterations increases.

For example, the masking unit 113 includes a process of randomly selecting a patch and setting a value of the selected patch to 0. For example, when the number of patches consists of 32 and the initial 5 patches are randomly selected, values of these initial 5 patches are set to 0.

In other words, the masking unit 113 may perform a process of randomly selecting and masking patches having a specific ratio from the patched data. All values of the masked patches may be set to zero, or the masked patches may be replaced with a specific embedding vector.

Furthermore, the masking unit 113 may set a masking ratio (the ratio of patches to be masked) within a range from 0% to 100%, and may also include a function of adjusting the masking ratio such that it is capable of gradually changing during a learning process.

In additional, the masking unit 113 may select a patch to be masked based on a temporal position or a specific pattern of data included in the plurality of patches.

In detail, the masking unit 113 may include a function of selectively masking a patch based not only on a random masking method but also on specific patterns (e.g., a high-frequency region or a low-frequency region) of data or temporal positions. Through this configuration, the device 100 according to an embodiment of the present disclosure may learn the data characteristics of a specific region.

Besides, the masking unit 113 may be designed such that the selected patch is capable of being masked across all channels, not limited to a specific channel of the multivariate time series data. In this way, the device 100 according to an embodiment of the present disclosure may perform training such that restoration is possible while the correlation between masked and unmasked channels is maintained.

The first embedding unit 114 may perform positional encoding on temporal positions of the input data patched into the plurality of patches, may expand it to a fixed embedding size (Projection Layer), and may perform high-dimensional feature transformation through value embedding.

In detail, the first embedding unit 114 may perform high-dimensional feature transformation on the masked data by applying Positional Encoding, Projection, and 1D Convolution.

The first embedding unit 114 may perform a process of data into high-dimensional features through positional encoding and projection, and may perform 1D convolution and pre-training for value embedding.

A sinusoidal method using sine and cosine functions may be used for the positional encoding.

Data may be extended to 512 dimensions in the projection.

The first embedding unit 114 performs an embedding process on the query, key, and value for the input of the first transformer encoder unit (Transformer Encoder) 115. The 1D convolution may be used for the value embedding.

In particular, to convert the patched input data into a high-dimensional vector representation suitable for the first transformer encoder unit (Transformer Encoder) 115, the first embedding unit 114 may encode the temporal position of a patch through the positional encoding and may expand the dimension of the input data to a fixed embedding size through the projection layer. In this process, the embedding dimension may be set to 512. Moreover, the first embedding unit 114 performs value embedding via the 1D Convolution Layer and may improve training stability by applying a pre-trained weight during the early training stage.

The first transformer encoder unit 115 may learn the model by receiving the input data transformed by the first embedding unit 114 in units of patch.

As described above, the model may be an artificial intelligence model described above in this specification. The model may be a model learned to perform an anomaly detection operation on multivariate time series data.

Furthermore, the model may be the pre-training unit 110 or the downstream unit 120, or may be implemented as a combination of at least one component included therein. For example, the model may be implemented as at least one component included in the pre-training unit 110 (e.g., the first embedding unit 114, the first transformer encoder unit 115, the first linear layer unit 116, and the reconstruction unit 117).

Furthermore, the model may be the first transformer encoder unit 115 and the second transformer encoder unit 125 itself, may be the entire processor 180, or may be the device itself according to an embodiment of the present disclosure.

The first transformer encoder unit 115 may perform high-dimensional processing on data input in the patch unit, and a vector value used in the high-dimensional processing mechanism may use the data output from the first embedding unit.

Here, the high-dimensional processing mechanism may include a process of multi-head attention, a feedforward neural network, layer normalization, and residual connection.

The first transformer encoder unit 115 may perform a process of multi-head attention, feedforward neural network, layer normalization, and residual connection to process input data in a high-dimensional manner.

Here, the first transformer encoder unit 115 may use data processed by the first embedding unit 114 for query, key, and value vectors for the multi-head attention operation.

Also, the first transformer encoder unit 115 may receive data in patch units, not point units. The data input to the first transformer encoder unit 115 may be embedded data from the first embedding unit 114.

For example, the first transformer encoder unit 115 may be implemented to use only the encoder of a vanilla transformer model.

The first linear layer unit 116 may perform a restoration task on the masked patch by deriving a prediction result, or refining the final representation of the data by using the output value from the first transformer encoder unit 115.

The first linear layer unit (Linear Layer) 116 may receive the output value of the first transformer encoder unit 115 and then may perform representation learning by predicting the masked data.

In detail, the first linear layer unit 116 may derive the prediction result, or refine the final representation of data by using the output value of the first transformer encoder unit 115, and may receive the generated feature vector to restore the masked data (patch).

That is, the output value from the first transformer encoder unit 115 includes a feature vector, and the first linear layer unit 116 may receive the feature vector and then may restore data for the masked patch.

The reconstruction unit 117 may reconstruct the restored data such that a difference between original data and the restored data is minimized, by predicting or estimating the original data before masking.

The reconstruction unit 117 may reconstruct the masked data by performing a reconstruction task through the input and output of the first linear layer unit 116.

The reconstruction unit 117 may be configured to perform a process of restoring the masked data as similarly as possible to the original data by predicting or estimating the original value of the masked data so as to minimize the difference between the original data and the restored data.

The first loss unit 118 may include a time loss function that calculates the difference between the restored data and the original data from a temporal perspective, and a frequency loss function that calculates the difference in the frequency spectrum by transforming the restored data and the original data into a frequency domain.

The time loss and the frequency loss may be derived by calculating a time loss, which is obtained when a loss function is calculated by predicting data masked by the first loss unit 118 and comparing the predicted data and the actual input data, and a frequency loss obtained by performing frequency-transformation on the input data and comparing a frequency value.

The first loss unit 118 may learn the model by reflecting both the time loss and the frequency loss.

The first loss unit 118 may be referred to as a “time loss and frequency loss unit”.

The time loss function included in the first loss unit 118 may be a loss function that calculates the difference between the restored data and the original data from a temporal perspective, and may be a regression loss function, such as the Mean Squared Error (MSE) or Mean Absolute Error (MAE).

The frequency loss function included in the first loss unit 118 may be a loss function that calculates the difference in the frequency spectrum by converting the original data and the restored data into the frequency domain, and may apply a Fast Fourier Transform (FFT) for frequency domain conversion.

The first loss unit 118 may calculate the loss by adjusting the importance of each of the time loss and the frequency loss by using arbitrary coefficients and may use calculated result for training.

With this configuration, the device 100 according to an embodiment of the present disclosure may perform pre-training by using self-supervised learning by decomposing the input multivariate time series data into patch units and performing random masking and reconstruction learning for masking restoration.

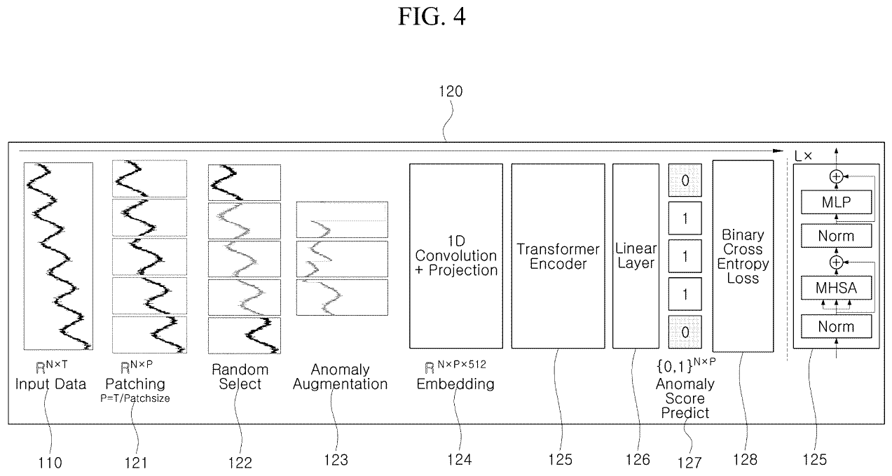

FIG. 4 is a diagram for describing a downstream unit, according to an embodiment of the present disclosure.

The downstream unit 120 includes the second patching unit 121 that receives multivariate time series data and divides it into a plurality of patches, the random selection unit 122 that randomly selects the plurality of patches, the anomaly augmentation unit 123 that synthesizes anomaly data such that anomaly enhancement is applied to data of the randomly selected patch, the second embedding unit 124 that performs high-dimensional feature transformation by applying a predetermined algorithm to a patch, to which the anomaly enhancement is applied, the second transformer encoder unit 125 that trains the model to receive the high-dimensional feature transformed data and to output an output value used for anomaly detection, the second linear layer unit 126 that performs binary classification used to calculate an anomaly score by using the output values from the second transformer encoder unit, the anomaly score prediction unit 127 that predicts an anomaly score for each of the plurality of patches by using a value output from the second linear layer unit, and the second loss unit 128 that calculates a difference between the anomaly score prediction result and the actual anomaly score result and uses the difference for training.

The second patching unit 121 may divide the input data into patch units of a specific patch size and may divide the data into a plurality of patches by selectively applying either an overlapping method or a non-overlapping method.

For example, when applying the overlapping method, the second patching unit 121 may determine the patch units based on an input data length, a patch size, and a stride.

The second patching unit 121 performs a patching process by dividing the input data into patches of the patch size. In this case, the patching process may or may not use an overlapping method. For example, when input time series data has a size of 128, the patch size is set to 4, and non-overlapping is set, the number of patches may be 32. When the overlapping method is set, it is set to “{(L−P)/S}+1” (here, a (L−P)/S value may be a discard or drop value, and may be a floor function). Here, ‘L’ is set to the data length; ‘P’ is set to the patch size; and ‘S’ is set to the stride.

In other words, the second patching unit 121 may include a process of dividing the input data into patches of a specific patch size, and may include a function of generating a patch unit based on the input data length ‘L’, the patch size ‘P’, and the stride ‘S’, and selectively applying either the overlapping method or the non-overlapping method, and a function for converting it into an input for anomaly enhancement and anomaly detection model learning.

The second patching unit 121 may analogically apply the functions, operations, and control methods described in the first patching unit 112 identically/similarly.

The random selection unit 122 may randomly select patches at a specific ratio from among the plurality of patches, and may variably set the ratio depending on a fixed ratio or a training stage.

Specifically, the random selection unit 122 may vary the ratio of selected patches and may gradually decrease the selection ratio as the number of training iterations increases. In this way, the device 100 according to an embodiment of the present disclosure may secure data diversity by randomly selecting patches at a high ratio in the early stages of learning, and may gradually reduce the random selection ratio in the later stages of learning, thereby inducing sophisticated learning.

This may be a distinguished feature from the masking unit 113 of the pre-training unit 110 that gradually increases the masking ratio as the number of training iterations increases.

The anomaly augmentation unit 123 may generate anomaly data by applying a predetermined technique to patches selected by the random selection unit 122.

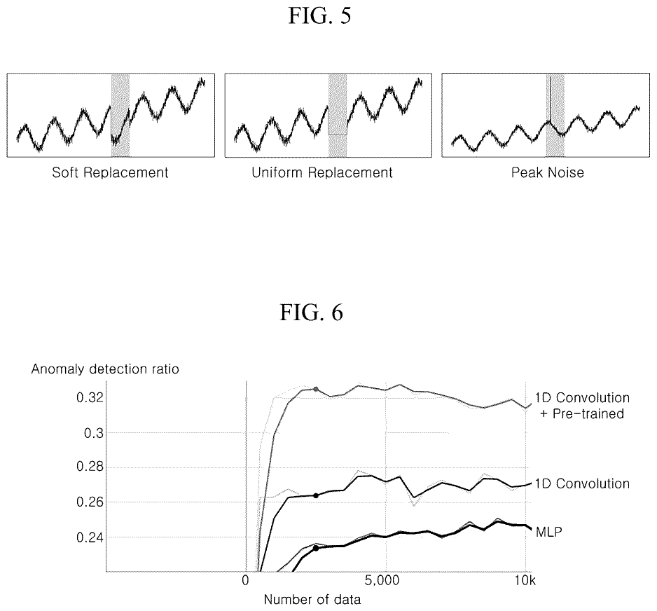

FIG. 5 is a diagram for describing anomaly data to which anomaly enhancement according to an embodiment of the present disclosure is applied.

The anomaly augmentation unit 123 may synthesize randomly selected data patches into anomaly data. Referring to FIG. 5, the predetermined technique may be achieved to synthesize at least one of a first technique (Soft Replacement), a second technique (Uniform Replacement), and a third technique (Peak Noise) with a certain probability.

The first technique (Soft Replacement) may be a technique that uses the average value of adjacent patches or a value based on a specific function as a replacement value.

The second technique (Uniform Replacement) may be a technique that replaces it with a random value within a variable or fixed range.

The third technique (Peak Noise) may be a technique that generates an anomaly situation by inserting a random high peak into an original value.

The anomaly augmentation unit 123 may apply Soft Replacement, Uniform Replacement, or Peak Noise to patches selected by the random selection unit 122 depending on a probability. For example, when the number of patches consists of 32 and the initial 5 patches are randomly selected, Soft Replacement may be applied with a 60% probability, Uniform Replacement may be applied with a 20% probability, and Peak Noise may be applied with a 20% probability.

The second embedding unit 124 may encode the temporal position of the input data patched into the plurality of patches, may expand it to a fixed embedding size, and may perform high-dimensional feature transformation through value embedding.

The second embedding unit 124 may perform high-dimensional feature transformation on patches converted into anomaly data in the anomaly augmentation unit 123.

The second embedding unit 124 may analogically apply the functions, operations, and control methods of the first embedding unit 114 identically/similarly.

The second embedding unit 124 may perform positional encoding on temporal positions of the input data patched into the plurality of patches, may expand it to a fixed embedding size (Projection Layer), and may perform high-dimensional feature transformation through value embedding.

In detail, the second embedding unit 124 may perform high-dimensional feature transformation on the anomaly-enhanced data by applying Positional Encoding, Projection, and 1D Convolution.

The second embedding unit 124 may perform a process of transforming data into high-dimensional features through positional encoding and projection, and may perform 1D convolution and pre-training for value embedding.

A sinusoidal method using sine and cosine functions may be used for the positional encoding.

Data may be extended to 512 dimensions in the projection.

The second embedding unit 124 performs an embedding process on the query, key, and value for the input of the second transformer encoder unit (Transformer Encoder) 125. The 1D convolution may be used for the value embedding.

In particular, to convert the patched input data into a high-dimensional vector representation suitable for the second transformer encoder unit (Transformer Encoder) 125, the second embedding unit 124 may encode the temporal position of a patch through the positional encoding and may expand the dimension of the input data to a fixed embedding size through the projection layer. In this process, the embedding dimension may be set to 512. Moreover, the second embedding unit 124 performs value embedding via the 1D Convolution Layer and may improve training stability by applying a pre-trained weight during the early training stage.

That is, the second embedding unit 124 performs a process of transforming data into high-dimensional features through positional encoding and projection, and includes a process of 1D convolution and pre-training for value embedding. The positional encoding utilizes a sinusoidal method using sine and cosine functions, and the projection expands to 512 dimensions. For input to the first transformer encoder unit 115, the value embedding may utilize 1D convolution during query, key, and value embedding processes.

The second transformer encoder unit 125 may learn the model by receiving the input data transformed by the second embedding unit 124 in units of patch. As illustrated in FIG. 1, the second transformer encoder unit 125 may be the first transformer encoder unit 115 pre-trained in the pre-training unit 110, or may be replaced with the first transformer encoder unit 115.

Moreover, the model may be an artificial intelligence model described above in this specification. The model may be a model learned to perform an anomaly detection operation on multivariate time series data.

Furthermore, the model may be the pre-training unit 110 or the downstream unit 120, or may be implemented as a combination of at least one component included therein. For example, the model may be implemented as at least one component included in the downstream unit 120 (e.g., at least one of the second embedding unit 124, the second transformer encoder unit 125, the second linear layer unit 126, and the anomaly score prediction unit 127).

Furthermore, the model may be the first transformer encoder unit 115 and the second transformer encoder unit 125 itself, may be the entire processor 180, or may be the device itself according to an embodiment of the present disclosure.

The second transformer encoder unit 125 may perform high-dimensional processing mechanism on data input in the patch unit, and a vector value used in the high-dimensional processing mechanism may use the data output from the second embedding unit 124.

The second transformer encoder unit 125 may include a process of supervised learning of anomaly-enhanced data based on the trained first transformer encoder unit 115.

The second linear layer unit 126 may perform binary classification that calculates an anomaly score for the selected patch by using the output value from the second transformer encoder unit 125, and may perform training to convert the output value into a probability value between 0 and 1.

The second linear layer unit 126 may analogically apply the functions, operations, and control methods described in the first linear layer unit 116 identically/similarly. The second linear layer unit 126 may be the first linear layer unit 116 or may be replaced with the first linear layer unit 116.

The output value output from the second transformer encoder unit 125 may include a feature vector.

The second linear layer unit 126 may receive the feature vector and then may perform binary classification that calculates an anomaly score for the selected patch.

In detail, the second linear layer unit 126 may receive an output feature vector of the second transformer encoder unit 125 to perform binary classification that calculates an anomaly score for the selected patch, and may use a sigmoid function as an activation function for converting the output value into a probability value between 0 and 1 to perform supervised learning.

The sigmoid function may be a type of activation function and may be a function formed to receive the weighted sum of input signals at each node of an artificial neural network and to convert and output it into a value between 0 and 1. For example, the converted value may be delivered to the next node and may be used for training and prediction of a deep learning model.

The second linear layer unit 126 may include an output process capable of predicting the correct label.

The anomaly score prediction unit 127 may receive the output value of the second linear layer unit 126, may calculate an anomaly score indicating whether data is abnormal, by using a sigmoid activation function, and may independently calculate an anomaly score for each patch.

That is, the anomaly score prediction unit 127 may include a process of predicting an anomaly situation by using a numerical value between 0 and 1 obtained through the second linear layer unit 126.

The second loss unit 128 may perform training by calculating a binary cross-entropy loss value such that the model trains a binary classification problem of normal and abnormal, and the difference between the calculated anomaly score and the actual data is minimized.

The second loss unit 128 may be called a “binary cross-entropy loss unit”.

The second loss unit 128 may calculate a binary cross-entropy loss value such that the model trains a binary classification problem of normal (0) and abnormal (1), and the difference between the calculated anomaly score and the actual label is minimized.

The second loss unit 128 may include a learning process based on the result (an output value) of the anomaly score prediction unit 127.

FIG. 6 is a graph illustrating the improvement in anomaly detection rate when the learning method according to an embodiment of the present disclosure is used.

It may be identified that utilizing 1D Convolution and pre-training is superior to a conventional MLP method when value embedding for an input to the first and second transformer encoder units (Transformer Encoder) is applied.

As discussed above, the present disclosure may relate to a device, a technology, and a method of patch-based self-supervised learning for anomaly detection in multivariate time series data, and may provide a framework for addressing issues such as data insufficiency, ignoring interactions between variables, limitations in learning local and global dependencies, and difficulties in processing new anomaly patterns. Moreover, the present disclosure provides a device and a method that divides input data into patch units, randomly masks some of them, and performs training by using a transformer encoder in a pre-training stage, and applies an anomaly enhancement technique to the selected patch such that the model trains various anomaly situations in a downstream anomaly detection stage.

The present disclosure proposes patch-based learning and a novel self-supervised learning framework utilizing a transformer encoder for anomaly detection in multivariate time series data, thereby overcoming the limitations of conventional techniques.

Moreover, the present disclosure combines unsupervised learning with data augmentation techniques to address data insufficiency, thereby effectively capturing local and global data characteristics through inter-channel dependency learning and frequency domain learning.

Furthermore, the present disclosure performs representation learning while preserving data continuity, and learns various anomaly patterns, thereby providing more sophisticated anomaly detection performance than conventional models.

Also, the present disclosure transforms input data into a high-dimensional feature space by using positional encoding and 1D convolution-based value embedding, thereby effectively training temporal dependency and inter-channel dependency.

In addition, the present disclosure may process complex interactions of multivariate time series data occurring in various industries and may perform anomaly detection.

Effects of the present disclosure are not limited to the effects mentioned above, and other effects not mentioned will be apparent by those skilled in the art from the following description.

The operation, function, and control method of the patch-based self-supervised learning device for anomaly detection of multivariate time series data described in the present disclosure may be analogously/similarly applied to a patch-based self-supervised learning method for anomaly detection of multivariate time series data or a control method of a patch-based self-supervised learning device for anomaly detection of multivariate time series data.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A patch-based self-supervised learning device for anomaly detection in multivariate time series data, the device comprising:
a memory configured to store at least one process for performing an anomaly detection operation on the multivariate time series data; and
a processor configured to perform the anomaly detection operation on the multivariate time series data based on the at least one process,
wherein the processor includes:
a pre-training unit configured to pre-train a model so as to restore the multivariate time series data by dividing the multivariate time series data into a plurality of patches, generating a patch, which is randomly masked, from among the plurality of patches, and reconstructing the masked patch; and
a downstream unit configured to perform self-learning so as to divide the multivariate time series data into the plurality of patches, randomly apply anomaly enhancement to the plurality of patches, and detect a patch, to which the anomaly enhancement is applied, by using the pre-trained model.

2. The device of claim 1, wherein the pre-training unit includes:
a data input unit configured to input the multivariate time series data;
a first patching unit configured to divide data input from the data input unit into the plurality of patches;
a masking unit configured to randomly select the plurality of patches and to mask a data value;
a first embedding unit configured to perform high-dimensional feature transformation by applying a predetermined algorithm on the masked patch;
a first transformer encoder unit configured to train the model so as to receive data, which is obtained by performing the high-dimensional feature transformation, and to output an output value used for data restoration;
a first linear layer unit configured to perform a restoration task on the masked patch by using the output value output from the first transformer encoder unit;
a reconstruction unit configured to estimate original data before masking and to reconstruct data restored by the first linear layer unit based on the estimated original data; and
a first loss unit configured to calculate a difference between the original data and the data restored through the reconstruction unit in terms of a time and a frequency and to use the difference for training.

3. The device of claim 2, wherein the first patching unit is configured to:
divide the input data into a patch unit having a specific patch size and divide the data into the plurality of patches by selectively applying either an overlapping method or a non-overlapping method; and
when applying the overlapping method, determine the patch unit based on an input data length, a patch size, and a stride.

4. The device of claim 2, wherein the masking unit is configured to:
randomly select and mask a patch at a specific ratio from among the plurality of patches;
perform masking by setting a data value included in the selected patch to 0 or replacing the data value with a specific embedding vector; and
vary a ratio of the masked patch, and gradually increase a masking ratio as the number of training iterations increases.

5. The device of claim 2, wherein the masking unit is configured to:
select a patch to be masked based on a temporal position or a specific pattern of data included in the plurality of patches.

6. The device of claim 2, wherein the first embedding unit is configured to:
encode a temporal position of input data patched into the plurality of patches;
expand the encoded result to a fixed embedding size; and
perform the high-dimensional feature transformation through value embedding.

7. The device of claim 2, wherein the first transformer encoder unit is configured to:
train the model by receiving input data transformed by the first embedding unit in a patch unit; and
perform a high-dimensional processing mechanism on the data input in the patch unit, and
wherein a vector value used in the high-dimensional processing mechanism uses data output from the first embedding unit.

8. The device of claim 2, wherein the first linear layer unit is configured to:
perform a restoration task on the masked patch by deriving a prediction result or refining a final representation of data by using the output value from the first transformer encoder unit,
wherein the output value output from the first transformer encoder unit includes a feature vector, and
wherein the first linear layer unit is configured to:
receive the feature vector and restore data for the masked patch.

9. The device of claim 2, wherein the reconstruction unit is configured to:
reconstruct the restored data such that a difference between the original data and the restored data is minimized, by predicting or estimating the original data before masking.

10. The device of claim 2, wherein the first loss unit is configured to:
include a time loss function that calculates a difference between the restored data and the original data from a temporal perspective, and a frequency loss function that calculates a difference in a frequency spectrum by transforming the restored data and the original data into a frequency domain; and
train the model by reflecting both a time loss and a frequency loss.

11. The device of claim 1, wherein the downstream unit includes:
a second patching unit configured to receive the multivariate time series data and to divide the multivariate time series data into the plurality of patches;
a random selection unit configured to randomly select the plurality of patches;
an anomaly augmentation unit configured to synthesize anomaly data such that the anomaly enhancement is applied to data of the randomly selected patch;
a second embedding unit configured to perform high-dimensional feature transformation by applying a predetermined algorithm to a patch, to which the anomaly enhancement is applied;
a second transformer encoder unit configured to train the model so as to receive data, which is obtained by performing the high-dimensional feature transformation, and to output an output value used for the anomaly detection;
a second linear layer unit configured to perform binary classification used to calculate an anomaly score by using the output value from the second transformer encoder unit;
an anomaly score prediction unit configured to predict the anomaly score for each of the plurality of patches by using a value output from the second linear layer unit; and
a second loss unit configured to calculate a difference between a prediction result of the anomaly score and a result of an actual anomaly score and to use the difference for training.

12. The device of claim 11, wherein the second patching unit is configured to:
divide input data into a patch unit having a specific patch size and divide the data into the plurality of patches by selectively applying either an overlapping method or a non-overlapping method; and
when applying the overlapping method, determine the patch unit based on an input data length, a patch size, and a stride.

13. The device of claim 11, wherein the random selection unit is configured to:
randomly select patches at a specific ratio from among the plurality of patches, and variably set the ratio depending on a fixed ratio or a training stage; and
vary the ratio of the randomly selected patches, and gradually decrease a selection ratio as the number of training iterations increases.

14. The device of claim 11, wherein the anomaly augmentation unit is configured to:
generate the anomaly data by applying a predetermined technique to a patch selected by the random selection unit.

15. The device of claim 11, wherein the second embedding unit is configured to:
encode a temporal position of input data patched into the plurality of patches;
expand the encoded result to a fixed embedding size; and
perform the high-dimensional feature transformation through value embedding.

16. The device of claim 11, wherein the second transformer encoder unit is configured to:
train the model by receiving input data transformed by the second embedding unit in a patch unit; and
perform a high-dimensional processing mechanism on the data input in the patch unit, and
wherein a vector value used in the high-dimensional processing mechanism uses data output from the second embedding unit.

17. The device of claim 11, wherein the second linear layer unit is configured to:
perform binary classification that calculates an anomaly score for a selected patch by using the output value from the second transformer encoder unit; and
perform training to convert the output value into a probability value between 0 and 1.

18. The device of claim 17, wherein the output value output from the second transformer encoder unit includes a feature vector, and
wherein the second linear layer unit is configured to:
receive the feature vector and then perform binary classification that calculates an anomaly score for the selected patch.

19. The device of claim 11, wherein the second loss unit is configured to:
perform training by calculating a binary cross-entropy loss value such that the model trains a binary classification problem of normal and abnormal, and a difference between the calculated anomaly score and actual data is minimized.

20. A patch-based self-supervised learning method for anomaly detection of multivariate time series data, which is performed by a device, the method comprising:
pre-training a model so as to restore the multivariate time series data by dividing the multivariate time series data into a plurality of patches, generating a patch, which is randomly masked, from among the plurality of patches, and reconstructing the masked patch; and
performing self-learning so as to divide the multivariate time series data into the plurality of patches, randomly apply anomaly enhancement to the plurality of patches, and detect a patch, to which the anomaly enhancement is applied, by using the pre-trained model.
